(19) United States
(12) Patent Application Publication
(10) Pub. No.: US 2011/0043642 A1
(43) Pub. Date: Feb. 24, 2011

(54) METHOD FOR PROVIDING OBJECT INFORMATION AND IMAGE PICKUP DEVICE APPLYING THE SAME

(75) Inventors: Seung-dong YU, Osan-si (KR); Woo-yong Chang, Yongin-si (KR); Se-jun Park, Yongin-si (KR); Min-jeong Moon, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Gyeonggi-do (KR)

(21) Appl. No.: 12/862,406

(22) Filed: Aug. 24, 2010

(30) Foreign Application Priority Data
Aug. 24, 2009 (KR) 10-2009-0078274
Aug. 20, 2010 (KR) 10-2010-0080932

(51) Int. Cl. H04N 5/222

(52) U.S. Cl. 348/207.1; 348/E05.024; 348/333.02

(57) ABSTRACT

A method for providing object information and an image pickup device applying the same are provided. An image is picked up. The picked-up image or pattern information of an object included in the picked-up image is transmitted to an external server. Information on the object included in the picked-up image is received from the external server. The received information is displayed on a screen. Accordingly, a user can be provided with information on the object by taking a picture of the object.

### PRIORITY

This application claims priority under 35 U.S.C. §119(a) to Korean Patent Application No. 10-2009-0078274, filed on Aug. 24, 2009, and Korean Patent Application No. 10-2010-0080932, filed on Aug. 20, 2010, in the Korean Intellectual Property Office, the disclosures of which are incorporated herein by reference.

### BACKGROUND OF THE INVENTION

1. Field of the Invention

The present invention relates generally to a method for providing object information, and more particularly, to a method for providing object information included in an image picked up through an image pickup device.

2. Description of the Related Art

When a person encounters an unknown object, he/she may take a picture of the object using a camera in order to find out what the object is. Then, he/she discovers information about the object by consulting an encyclopedia or searching the Internet with reference to the photograph of the object.

As described above, when a user is encountered with a new object (or building, animal, or the like), he/she may devote a lot of time to find out what the object is.

Most portable phones are provided with cameras mounted thereon, and most people possess portable phones. Accordingly, most people possess cameras.

When a person encounters an unknown object, and the person takes a picture of the object, there is a need to easily providing information on the object using an image pickup device.

### SUMMARY OF THE INVENTION

The present invention has been made to address at least the above problems and/or disadvantages and to provide at least the advantages described below. Accordingly, an aspect of the present invention provides a method for providing object information and an image pickup device applying the same.

According to one aspect of the present invention, a method for providing object information is provided. An image is picked up. The picked-up image or pattern information of an object included in the picked-up image is transmitted to an external server. Information on the object included in the picked-up image is received from the external server. The received information is displayed on a screen.

The method for providing object information according to an embodiment of the present invention may further include transmitting the picked-up image to the external server if the external server cannot recognize the object only by the pattern data of the object.

The method for providing object information according to an embodiment of the present invention may further include displaying a category selection menu for selecting a category of the object included in the picked-up image.

The method for providing object information according to an embodiment of the present invention may further include transmitting category information selected from the category selection menu to the external server.

The method for providing object information according to an embodiment of the present invention may further include displaying a list of functions related to the object based on the information on the object; and performing the function selected from the list.

The method for providing object information according to an embodiment of the present invention may further include performing a function related to the object based on the object information.

The method for providing object information according to an embodiment of the present invention may further include recognizing a state of the picked-up image based on the information on the object and performing a function related to the state of the picked-up image.

According to another aspect of the present invention, an image pickup device is provided that includes an image sensor for picking up an image, and a communication unit communicably connected to an external server. The image pickup device also includes a control unit that operates to transmit the picked-up image or pattern information of an object included in the picked-up image to the external server, to receive information on the object included in the picked-up image from the external server, and to display the received information on a screen.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating in detail the configuration of an image pickup device, according to an embodiment of the present invention;

FIG. 2 is a flowchart illustrating a method for providing object information included in a picked-up image, according to an embodiment of the present invention;

FIG. 3A is a diagram illustrating a case where an information search command icon is touched in a state where a ladybird is photographed, according to an embodiment of the present invention;

FIG. 3B is a diagram illustrating a screen on which information on a ladybird is displayed, according to an embodiment of the present invention;

FIG. 4A is a diagram illustrating a case where an information search command icon is touched in a state where the Eiffel Tower is photographed, according to an embodiment of the present invention;

FIG. 4B is a diagram illustrating a screen on which information on the Eiffel Tower is displayed, according to an embodiment of the present invention;

FIGS. 5A to 5G are diagrams illustrating processes of providing information of an object included in a picked-up image, according to an embodiment of the present invention; and

FIG. 6 is a diagram illustrating a screen on which a category selection menu of an object before recognition of the object, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

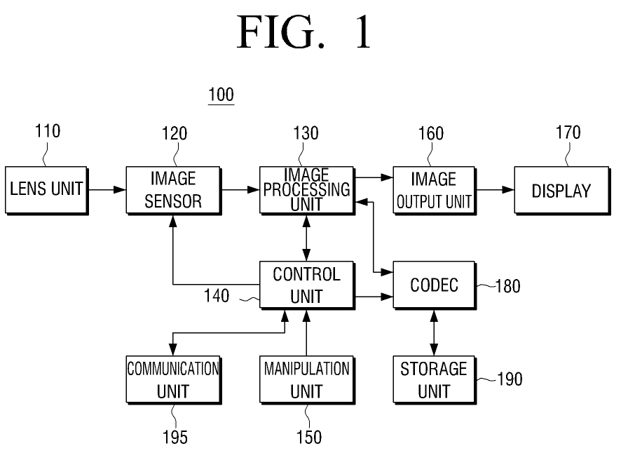

FIG. 1 is a block diagram illustrating in detail the configuration of an image pickup device, according to an embodiment of the present invention. As illustrated in FIG. 1, an image pickup device 100 includes a lens unit 110, an image sensor 120, an image processing unit 130, a control unit 140, a manipulation unit 150, an image output unit 160, a display 170, a codec 180, a storage unit 190, and a communication unit 195.

The lens unit 110 forms an optical image on an image pickup area by gathering light from an object.

The image sensor 120 performs a photoelectric transformation of the light incident through a lens into an electric signal, and performs a predetermined signal process with respect to the electric signal. The image sensor 120 that performs the above-described functions is provided with pixels and an Analog-to-Digital (AD) converter. The respective pixels output an analog image signal, and the AD converter converts the analog image signal into a digital image signal.

The image processing unit 130 performs a signal process with respect to an image input from the image sensor 120, and transmits the processed image signal to the image output unit 160 in order to display the picked-up image. Also, the image processing unit 130 outputs the processed image signal to the codec 180 to store the picked-up image.

Specifically, the image processing unit 130 performs format conversion, digital zooming for controlling an image scale, Auto White Balance (AWB), Auto Focus (AF), Auto Exposure (AE), and the like, with respect to the image signal output from the image sensor 120.

Also, the image processing unit 130 extracts an object included in the picked-up image. Herein, the object refers to an object of the picked-up image. Examples of the object include a person, a building, an animal, an insect, and the like.

Specifically, the image processing unit 130 extracts pattern information of the object included in the picked-up image. For example, the image processing unit 130 detects a boundary portion of the object and recognizes the boundary portion as the pattern information of the object. Also, the image processing unit 130 recognizes the change of color around the detected boundary, a pattern of the boundary, and the contour of the object based on the boundary. The image processing unit 130 extracts the object included in the picked-up image based on the pattern information including the color, pattern, and contour as described above.

Also, the image processing unit 130 transmits the extracted pattern information to the control unit 140. Then, the control unit 140 extracts a reference image that corresponds to the pattern information by comparing the extracted pattern information with reference images. Herein, the reference images refer to representative images of the respective objects for recognizing the object.

As described above, the image processing unit 130 extracts the object included in the picked-up image.

Also, the image processing unit 130 receives an image of content stored in the storage unit 190 through the codec 180 and processes the received image. The image processing unit 130 outputs the processed image of the content to the image output unit 160.

The image output unit 160 outputs the image signal received from the image processing unit 130 to the internal display 170 or an external output terminal.

The display 170 displays the picked-up image on the screen. Also, the display 170 may display information on the object included in the picked-up image in addition to the picked-up image.

The codec 180 encodes the image signal received from the image processing unit 130. The codec 180 transmits the encoded image to the storage unit 190. Also, the codec 180 decodes the encoded image signal of the content stored in the storage unit 190. The codec 180 transmits the decoded image signal to the image processing unit 130.

Specifically, the codec 180 encodes the picked-up image when storing the picked-up image, and decodes the stored content image when outputting the content image to the image processing unit 130.

The storage unit 190 stores the image picked-up by the image sensor 120 in a compressed form. Also, the storage unit 190 stores reference images for recognizing the object. The storage unit 190 also stores a database for searching for information on the object. For example, an encyclopedia database may be stored in the storage unit 190

The storage unit 190 may be implemented by using a flash memory, hard disc, DVD, and the like.

The manipulation unit 150 receives a command through a user's manipulation thereof. The manipulation unit 150 may be provided in the form of a button on the surface of the image pickup device 100 or in the form of a touch screen on the display 170. Also, the manipulation unit 150 receives an information search command for the picked-up object from the user. Herein, the information search command refers to a command that makes it possible to search for information on what the picked-up object is through the encyclopedia or the like, and to display the information.

The communication unit 195 is communicably connected to the external server through diverse networks, such as the Internet. The communication unit 195 may be connected to the external server using a wired network, such as a wired LAN, or a wireless network, such as a wireless LAN or Bluetooth.

The control unit 140 controls the whole operation of the image pickup device 100. Specifically, the control unit 140 operates to display the information on the object included in the image on the screen. Herein, the information on the object refers to detailed information on what the object is. For example, the information on the object may be the meaning of the object in the dictionary, information from the encyclopedia, or the like.

If an information search command is input through the manipulation unit 150, the control unit 140 controls the image processing unit 130 to extract the object from the picked-up image. Also, the control unit 140 extracts a reference image that corresponds to the pattern information by comparing the extracted pattern information with reference images. Herein, the reference images refer to representative images of the respective objects for recognizing the object. Also, the control unit 140 recognizes what the object included in the picked-up image is by determining that the object included in the corresponding reference image is identical to the picked-up image.

Examples of the object include a person, a building, an animal, an insect, and the like. Accordingly, if the object is a person, the control unit 140 extracts face pattern information of the object using face recognition technology, and searches for a corresponding face image among the reference images. If there is a corresponding reference image, the person indicated by the object of the picked-up image is identified as the person that corresponds to the reference image.

If the object is an insect, the control unit 140 extracts insect pattern information, and searches for a corresponding insect image among the reference images. If there is a corresponding reference image, the control unit 140 determines that the insect corresponding to the reference image is the insect that is indicated by the object of the picked-up image.

Through the above-described processes, the control unit 140 recognizes the object included in the picked-up image.

If there is a database for the object information in the storage unit 190, the control unit 140 searches for the information on the object in the database stored in the storage unit 190. The control unit 140 controls the display 170 to display the object information on the screen.

However, if the object cannot be recognized, the control unit 140 operates to transmit the picked-up image to the external server. Herein, the external server refers to a server that recognizes the object from the image and provides information on diverse objects. The external server has an excellent processing speed and storage capacity in comparison to those of the image pickup device 100. Thus, if the external server recognizes the object and searches for the information on the object, it becomes possible to recognize the object more accurately and to obtain more detailed object information. Accordingly, in the case where the control unit 140 cannot recognize the object, it transmits the picked-up image to the external server.

If the pattern information of the object is extracted, the control unit 140 may transmit only the pattern information to the external server. When transmitting all of the images, the processing speed may be lowered due to a high transmission rate. Accordingly, if the pattern information of the object can be recognized but the object cannot be recognized, the control unit 140 may transmit only the pattern information of the object to the external server. Thus, when providing the object information through the external server, the control unit 140 can improve the processing speed.

If the external server cannot recognize the object using only the pattern information of the object, the control unit 140 re-transmits the picked-up image to the external server. The external server is able to more accurately recognize the object based on the picked-up image.

The control unit 140 receives a recognition result of the object included in the picked-up image from the external server. The control unit 140 then receives the recognized object information from the external server.

If there is no database for the object information in the storage unit 190, the control unit 140 requests information on the object recognized by the external server. The external server searches for information on the object in the built-in encyclopedia database or the database on the Internet, and provides the searched information on the object to the image pickup device. Accordingly, the control unit 140 operates to receive the information on the object from the external server.

The control unit 140 operates to display the received object information on the screen.

As described above, the control unit 140 can provide the information on the object included in the picked-up image. Accordingly, the user can easily confirm the information on the corresponding object by photographing the specified object.

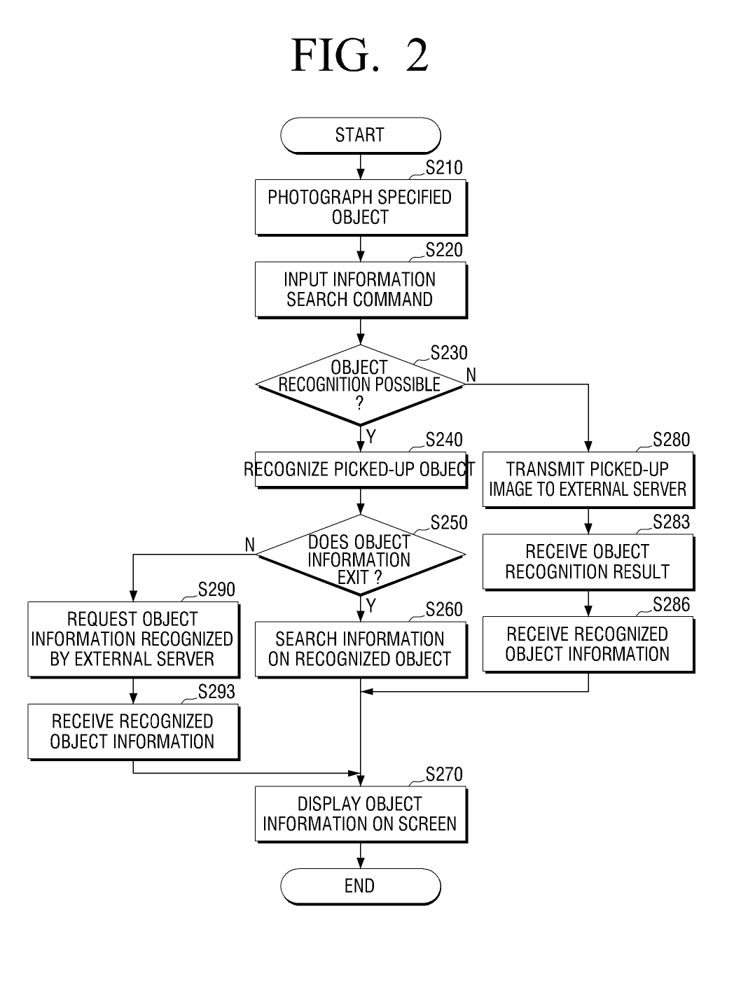

FIG. 2 is a flowchart illustrating a method for providing object information included in a picked-up image, according to an embodiment of the present invention.

The image pickup device 100 picks up an image that includes a specified object in step S210. The image pickup includes not only storage of the image sensed by the image sensor 120 by the image pickup device 100, but also an image pickup standby state where the image pickup device 100 displays the image sensed by the image sensor 120 on the display 170.

The image pickup device 100 receives an information search command for the picked-up object through user manipulation in step S220. The information search command is a command for searching for information on what the picked-up image is through an encyclopedia or the like, and displaying the information on the screen.

If the information search command is input, the image pickup device 100 determines whether the object included in the picked-up image can be recognized in step S230. If it is possible to recognize the object included in the picked-up image, the image pickup device 100 extracts the object from the picked-up image in step S240.

Specifically, the image pickup device 100 extracts the pattern information of the object included in the picked-up image. For example, the image pickup device 100 detects a boundary portion of the object from the picked-up image, and recognizes the boundary portion as the pattern information of the object. Also, the image pickup device 100 recognizes a change of color around the detected boundary, a pattern of the boundary, and a contour of the object based on the boundary. The image pickup device 100 extracts the object included in the picked-up image based on the pattern information including the color, pattern, and contour, as described above.

The image pickup device 100 extracts a reference image to which the pattern information corresponds by comparing the extracted pattern information with reference images. Herein, the reference images refer to representative images of the respective objects for recognizing the object. Also, the image pickup device 100 recognizes what the object included in the picked-up image is by determining that the object included in the corresponding reference image is identical to the picked-up object.

Examples of the object include a person, a building, an animal, an insect, and the like. Accordingly, if the object is a person, the image pickup device 100 extracts face pattern information of the object using face recognition technology, and searches for a corresponding face image among the reference images. If there is a corresponding reference image, a person indicated by the object of the picked-up image is identified as the person that corresponds to the reference image.

Also, if the object is an insect, the image pickup device 100 extracts insect pattern information, and searches for a corresponding insect image among the reference images. If there is the corresponding reference image, the insect corresponding to the reference image is used to identify the insect that is indicated by the object of the picked-up image.

Through the above-described processes, the image pickup device 100 recognizes the object included in the picked-up image.

Thereafter, the image pickup device 100 determines whether there is the object information in the storage unit 190 in step S250. A database is stored in the storage unit 190 for searching for information on various kinds of objects. For example, an encyclopedia database may be stored in the storage unit 190.

Accordingly, if there is a database for the object information in the storage unit 190 of the image pickup device 100, the image pickup device 190 searches for the information on the object in the database stored in the storage unit 190 in step S260.

The image pickup device 100 then displays the searched object information on the screen in step S270.

By contrast, if the image pickup device 100 cannot recognize the object in step S230, the image pickup device 100 transmits the picked-up image to the external server in step S280. The external server is a server that recognizes the object from the image and provides information on diverse objects. The external server has an excellent processing speed and storage capacity in comparison to those of the image pickup device 100. Thus, if the external server recognizes the object and searches for the information on the object, it becomes possible to recognize the object more accurately and to obtain more detailed object information. Accordingly, when the image pickup device 100 cannot recognize the object, it transmits the picked-up image to the external server.

However, when extracting the pattern information of the object, the image pickup device 100 may transmit only the pattern information to the external server. When transmitting all of the images, the processing speed may be lowered due to a high transmission rate. Accordingly, if the pattern information of the object can be recognized but the object cannot be recognized, the image pickup device 100 may transmit only the pattern information of the object to the external server. Thus, when providing the object information through the external server, the image pickup device 100 can improve the processing speed.

If the external server cannot recognize the object only by the pattern information of the object, the image pickup device 100 re-transmits the picked-up image to the external server. The external server can more accurately recognize the object based on the picked-up image.

The image pickup device 100 receives a recognition result of the object included in the picked-up image from the external server in step S283. The image pickup device 100 then receives the recognized object information from the external server in step S286.

If there is no database for the object information in the image pickup device 100 in step S250, the image pickup device 100 requests the information on the object recognized by the external server in step S260. The external server searches for the information on the object in the built-in encyclopedia database, and provides the searched information on the object to the image pickup device. The external server also searches for the information on the object in databases (e.g. portal sites such as Yahoo, Google, NAVER, or the like) on the Internet, and provides the searched information on the object to the image pickup device. Accordingly, the image pickup device 100 receives the information on the object from the external server in step S293.

Thereafter, the image pickup device 100 displays the received object information on the screen in step S270.

Through the above-described processes, the image pickup device 100 can provide the object information included in the picked-up image. Accordingly, the user can easily confirm information on an object through photographing the object.

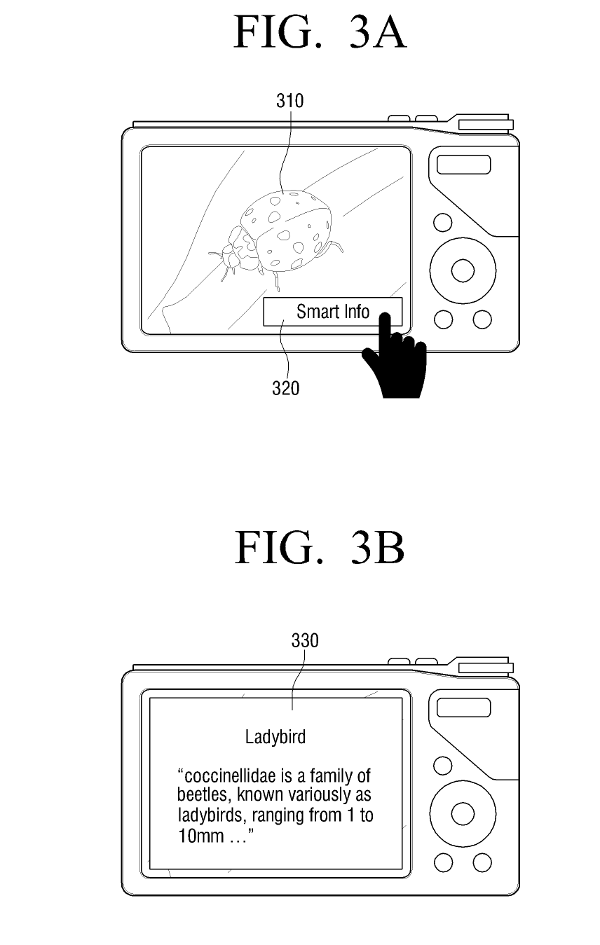

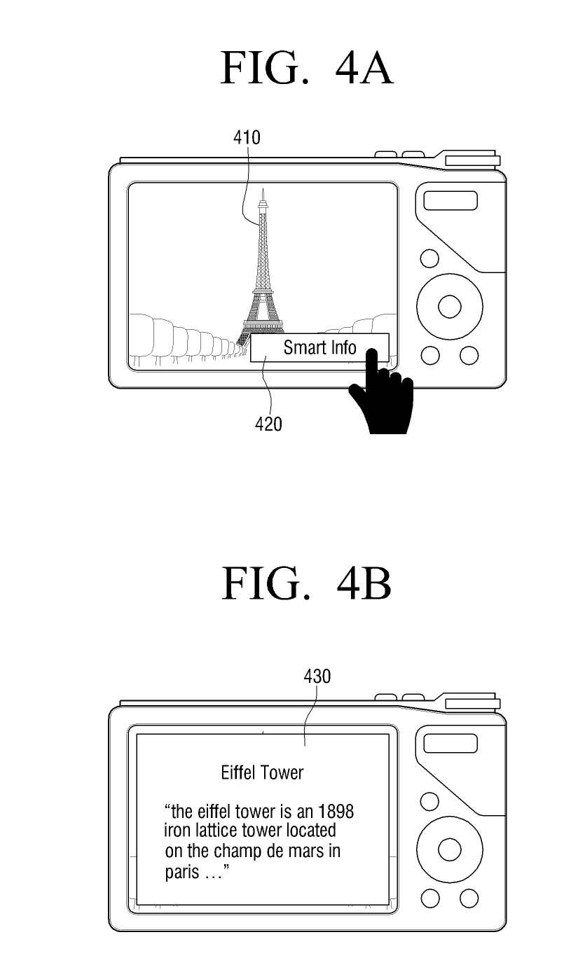

Hereinafter, with reference to FIGS. 3A to 4B, a process of displaying object information included in the picked-up image will be described. FIG. 3A is a diagram illustrating a case where an information search command icon 320 is touched in a state where a ladybird 310 is photographed, according to an embodiment of the present invention. FIG. 3B is a diagram illustrating a screen on which information on a ladybird 310 is displayed, according to an embodiment of the present invention.

As illustrated in FIG. 3A, the user takes a picture of a ladybird 310 using the image pickup device 100. If the user touches the information search command icon 320, the image pickup device 100 recognizes the photographed ladybird 310 as an object, and searches for information on the ladybird 310 in the database stored in the storage unit 190.

If the image pickup device 100 cannot recognize the ladybird 310, the image pickup device 100 may transmit the photographed image to the external server. The image pickup device 100 then receives the information on the ladybird 310 from the external server.

As illustrated in FIG. 3B, the image pickup device 100 recognizes the object included in the picked-up image as the ladybird 310, searches for or receives the information on the ladybird 310, and displays the searched information on the screen.

FIG. 4A is a diagram illustrating a case where an information search command icon 420 is touched in a state where the Eiffel Tower 410 is photographed, according to an embodiment of the present invention. FIG. 4B is a diagram illustrating a screen on which information on the Eiffel Tower 410 is displayed, according to an embodiment of the present invention.

As illustrated in FIG. 4A, the user takes a picture of the Eiffel Tower 410 using the image pickup device 100. If the user touches the information search command icon 420, the image pickup device 100 recognizes the photographed Eiffel Tower 410 as an object, and searches for information on the Eiffel Tower 410 in the database stored in the storage unit 190.

If the image pickup device 100 cannot recognize the Eiffel Tower 410, the image pickup device 100 may transmit the photographed image to the external server. The image pickup device 100 then receives the information on the Eiffel Tower 410 from the external server.

As illustrated in FIG. 4B, the image pickup device 100 recognizes the object included in the picked-up image as the Eiffel Tower 410, searches for or receives the information on the Eiffel Tower, and displays the searched information on the screen.

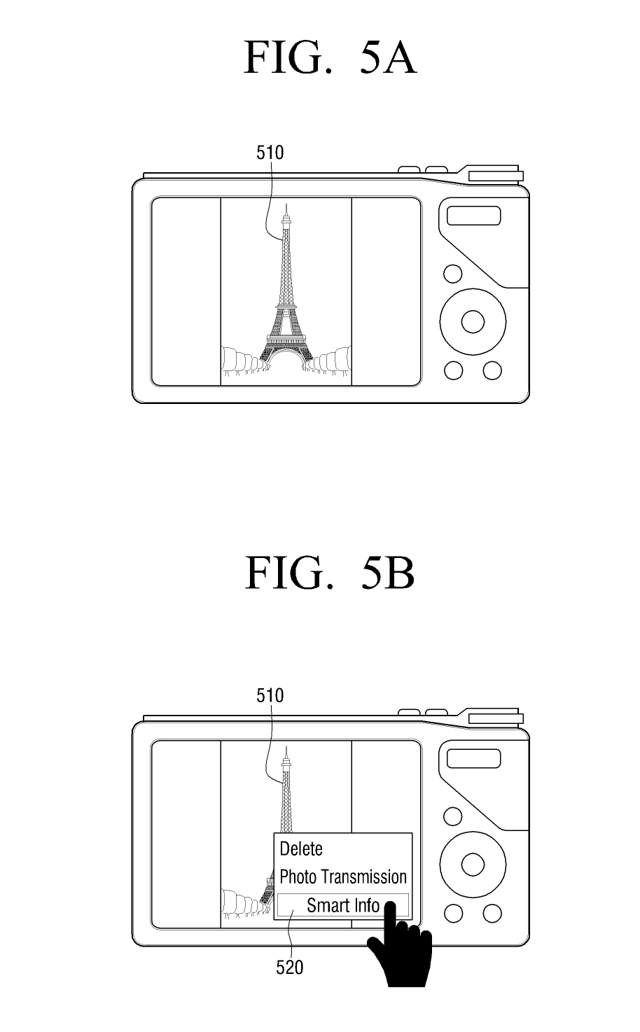

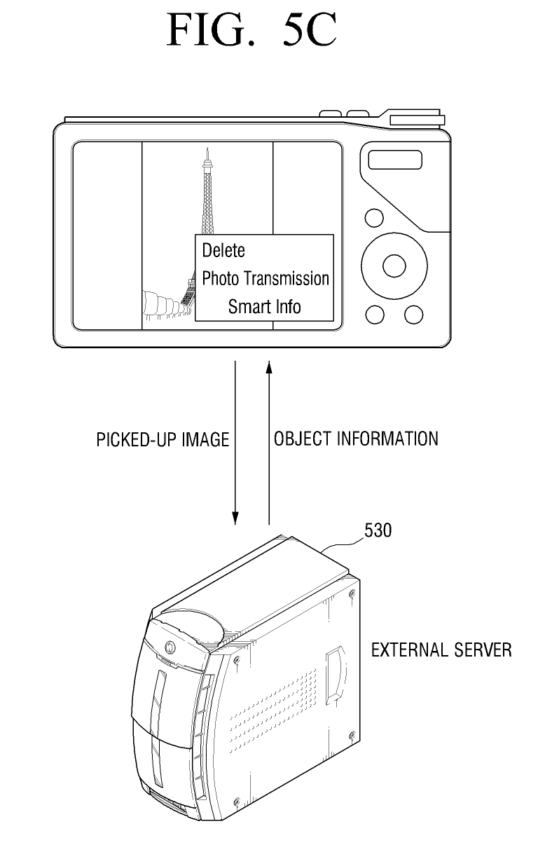

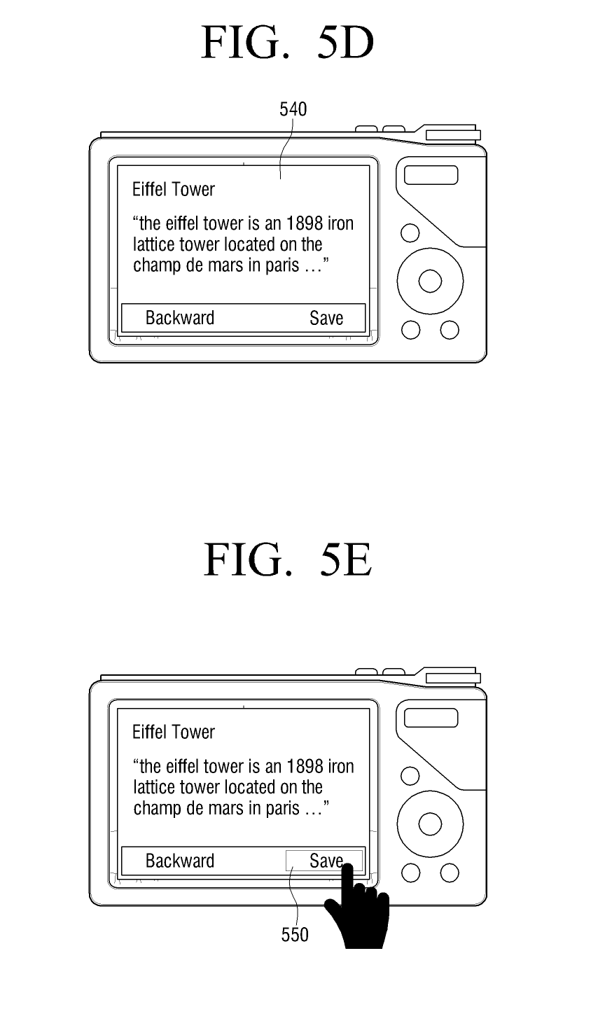

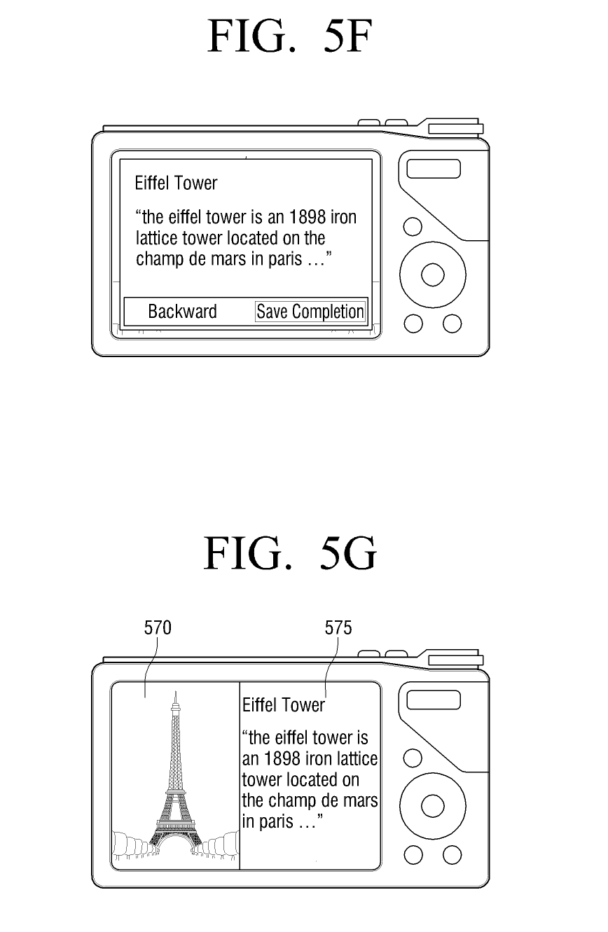

Hereinafter, with reference to FIGS. 5A to 5G, the process of providing object information included in the image picked up by the image pickup device 100 will be described. FIGS. 5A to 5G are diagrams illustrating diverse processes of providing object information included in a picked-up image, according to an embodiment of the present invention

FIG. 5A shows a state where the image pickup device 100 takes a picture of the Eiffel Tower 510. Thereafter, as illustrated in FIG. 5B, the image pickup device 100 displays a menu that includes an information search command item 520 on the screen.

As shown in FIG. 5B, if a user touches the information search command item 520, the image pickup device 100 transmits the picked-up image to an external server 530, as shown in FIG. 5C. The image pickup device 100 receives information on the Eiffel Tower 510 (the object information) from the external server 530. Specifically, the external server 530 recognizes that the object included in the picked-up image is the Eiffel Tower 510, searches for the information on the Eiffel Tower 510, and transmits the searched information to the image pickup device 100.

As shown in FIG. 5D, the image pickup device 100 displays information 540 on the Eiffel Tower on the screen. As shown in FIG. 5E, if the user touches a storage button 550, the image pickup device 100 stores the information 540 on the Eiffel Tower displayed on the screen in the storage unit 190. As shown in FIG. 5F, if the storage of the information 540 on the Eiffel Tower is completed, the image pickup device 100 displays that the storage has been completed on the screen.

The image pickup device 100 can store the information on the object displayed on the screen in the storage unit 190. Accordingly, the user can repeatedly confirm the object information once searched through a stored file.

The image pickup device 100 can display both the picked-up image and the searched object information. Specifically, as shown in FIG. 5G, the image pickup device 100 can display picked-up image 570 of the Eiffel Tower and information 575 on the Eiffel Tower together. Accordingly, the user can confirm both the picked-up image and the object information included in the image.

Through the above-described processes, the image pickup device 100 can provide the object information included in the picked-up image. Accordingly, the user can easily confirm the information on the corresponding object by photographing the object.

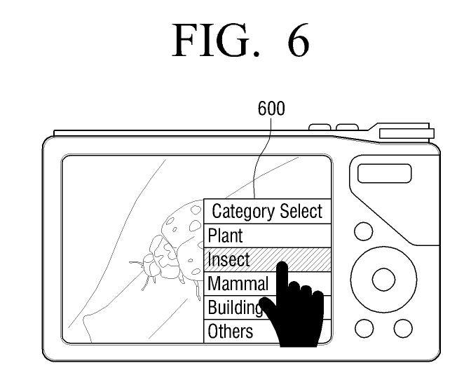

Hereinafter, with reference to FIG. 6, the selection of an object category before the object is recognized will be described. FIG. 6 is a diagram illustrating a screen on which a category selection menu 600 of an object is displayed before recognition of the object, according to an embodiment of the present invention.

As illustrated in FIG. 6, the image pickup device 100 displays the category selection menu 600 on the screen. Herein, the category refers to a category of the kinds of objects included in the picked-up image. For example, as shown in FIG. 6, the category may include a plant, an insect, a mammal, a building, and others.

If the information search command is input (i.e. after step S220 in FIG. 2), the image pickup device 100 may display the category selection menu 600. Accordingly, a user can select which category the object included in the picked-up image belongs to. The image pickup device recognizes an object in the category selected by the user. Accordingly, the image pickup device can recognize the object more accurately and at a higher speed, and can search the object information.

Also, the image pickup device 100 may transmit the information on the selected category to the external server. The external server the recognizes the object with reference to the selected category, and thus, can recognize the object more accurately and promptly.

The image pickup device 100 may display a list of functions related to the object using the object information received from the server, or may perform the function related to the object.

For example, if the received object information is a vehicle, the image pickup device 100 may perform functions of making a phone call to the nearest auto repair shop or displaying a map of the nearest gas station. Also, the image pickup device 100 may display a list of functions related to a vehicle and perform a function selected by a user.

Also, if the receive object information is a puppy, the image pickup device 100 may perform functions of making a phone call to the nearest veterinary hospital or a pet center, or performing an Internet site search for a method of keeping a pet dog. Also, the image pickup device 100 may display a list of functions related to a puppy and perform a function selected by the user.

Since the image pickup device 100 can automatically perform the functions related to the object included in the picked-up image, the user can perform a desired function by photographing a specified object.

Also, the image pickup device 100 may recognize the state that is indicated by an image based on the objection information of the picked-up image. If a specified state is recognized, the image pickup device 100 may perform a function that copes with the corresponding state.

For example, if two standstill vehicles are included in the picked-up image, the image pickup device 100 may recognize this state as an accident state. Accordingly, if the accident state is recognized, the image pickup device 100 performs functions related to the accident state. For example, the image pickup device 100 may perform functions of making a call to an automobile insurance company or display the phone number of the automobile insurance company.

Also, if fire is included over the picked-up image, the image pickup device 100 may recognize this as a fire state. The image pickup device 100 then performs functions related to the fire state. For example, the image pickup device 100 may produce siren sounds or make a call to a firehouse.

As described above, the image pickup device 100 may recognize the state of the picked-up image and perform functions related to the state.

In this embodiment of the present invention, it is sufficient if the image pickup device 100 is a device that can pick up an image. For example, the image pickup device 100 may be a portable phone having a camera mounted thereon, an MP3 player, a PDA, a notebook computer, and the like.

While the invention has been shown and described with reference to certain embodiments thereof, it will be understood by those skilled in the art that various changes in form and detail may be made therein without departing from the spirit and scope of the invention, as defined by the appended claims.

What is claimed is:

1. A method for providing object information, comprising the steps of:
picking up an image;
transmitting the picked-up image or pattern information of an object included in the picked-up image to an external server;
receiving information on the object included in the image from the external server; and
displaying the received information on a screen.

2. The method as claimed in claim 1, wherein the pattern information is transmitted to the external server when the pattern information of the object included in the picked-up image is extracted.

3. The method as claimed in claim 1, further comprising transmitting the picked-up image to the external server when the external server cannot recognize the object by the pattern data of the object.

4. The method as claimed in claim 1, wherein the picked-up image is transmitted to the external server when the pattern information of the object included in the picked-up image is not extracted.

5. The method as claimed in claim 1, wherein the received information is displayed together with the picked-up image.

6. The method as claimed in claim 1, further comprising displaying a category selection menu for selecting a category of the object included in the picked-up image.

7. The method as claimed in claim 6, further comprising transmitting category information selected from the category selection menu to the external server.

8. The method as claimed in claim 1, further comprising:
displaying a list of functions related to the object based on the information on the object; and
performing a function selected from the list.

9. The method as claimed in claim 1, further comprising performing a function related to the object based on the information on the object.

10. The method as claimed in claim 1, further comprising recognizing a state of the picked-up image based on the information on the object and performing a function related to the state of the picked-up image.

11. An image pickup device comprising:
an image sensor for picking up an image;
a communication unit communicably connected to an external server; and
a control unit that operates to transmit the picked-up image or pattern information of an object included in the picked-up image to the external server, to receive information on the object included in the picked-up image from the external server, and to display the received information on a screen.

12. The image pickup device as claimed in claim 11, wherein the control unit operates to transmit the pattern information to the external server when the pattern information of the object included in the picked-up image is extracted.

13. The image pickup device as claimed in claim 11, wherein the control unit operates to transmit the picked-up image to the external server when the external server cannot recognize the object by the pattern data of the object.

14. The image pickup device as claimed in claim 11, wherein the control unit operates to transmit the picked-up image to the external server when the pattern information of the object included in the picked-up image is not extracted.

15. The image pickup device as claimed in claim 11, wherein the control unit operates to display the received information together with the picked-up image.

16. The image pickup device as claimed in claim 11, wherein the control unit operates to display a category selection menu for selecting a category of the object included in the picked-up image.

17. The image pickup device as claimed in claim 16, wherein the control unit operates to transmit category information selected from the category selection menu to the external server.

18. The image pickup device as claimed in claim 11, wherein the control unit operates to display a list of functions related to the object based on the information on the object, and to perform a function selected from the list.

19. The image pickup device as claimed in claim 11, wherein the control unit operates to perform a function related to the object based on the information on the object.

20. The image pickup device as claimed in claim 11, wherein the control unit operates to recognize a state of the picked-up image based on the information on the object and to perform a function related to the state of the picked-up image.
